(19) United States
(12) Patent Application Publication
(10) Pub. No.: US 2025/0370742 A1
(43) Pub. Date: Dec. 4, 2025

(54) SYSTEM AND METHOD FOR AUTOMATED IMPROVEMENT ACROSS SOFTWARE PRODUCTS

(71) Applicant: Zoho Corporation Private Limited, Kanchipuram District (IN)

(72) Inventors: Manikanda Vignesh Soundararajan, Salem (IN); Rakesh Jayaprakash, Chennai (IN); Rajah Ganesh Thamizhchelvan, Kanchipuram District (IN); Shailesh Kumar Davey, Kanchipuram District (IN); Punithavathi Palani, Chennai (IN); Sudheer A. Grandhi, Pleasanton, CA (US)

(73) Assignee: Zoho Corporation Private Limited, Kanchipuram District (IN)

(21) Appl. No.: 19/223,188

(22) Filed: May 30, 2025

Related U.S. Application Data
(60) Provisional application No. 63/674,984, filed on Jul. 24, 2024.

(30) Foreign Application Priority Data
Jun. 4, 2024 (IN) 202441043340

(51) Int. Cl. G06F 8/656

(52) U.S. Cl. CPC G06F 8/656

(57) ABSTRACT

A software ecosystem dynamically improves the performance and interoperability of software products controlled and operated by product managers within the same or different businesses. A product enhancer analyzes logs of the software products for cross-product user activities and identifies contextual parameters that may impact the separate or collective performance of the software products for users simultaneously engaging with multiple products. The product enhancer can then modify one or more of the software products using contextual parameters derived from or with events and information from other software products to improve the user's overall experience and the collective performance of the software ecosystem of the interoperable products.

### CROSS REFERENCE TO RELATED APPLICATIONS

This application claims priority under 35 U.S.C. 119 (e) to U.S. Provisional Patent Application 63/674,984 entitled “SYSTEM AND METHOD FOR PROCESS DISCOVERY USING EVENT LOGS AND ITS SOURCES” to Soundararajan et al. filed 24 Jul. 2024 and under 35 U.S.C. 119 (a) to Indian Provisional Patent Application 20/244,1043340 likewise entitled “SYSTEM AND METHOD FOR PROCESS DISCOVERY USING EVENT LOGS AND ITS SOURCES” and to Soundararajan et al. filed 4 Jun. 2024, both of which are incorporated herein by reference.

### FIELD OF THE INVENTION

The subject matter presented herein relates generally to network-based software products.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a software ecosystem 100 that dynamically improves the performance and interoperability of software products controlled and operated by product managers within the same or different businesses.

FIG. 2 depicts a software ecosystem 200 in accordance with another embodiment with like-identified elements being the same or similar to those of FIG. 1.

FIG. 3 shows a flowchart (300) that illustrates process discovery performed by an embodiment of product enhancer 105 from merged log 248 for first and second products 207 and 217 of FIG. 2.

FIG. 4 shows a taxonomy diagram 400 of collecting different event logs and its corresponding sources.

FIG. 5 depicts an example of an event log for a purchase process in table form. All individual events are listed in the event log along with the standard available properties.

FIG. 6 is a flowchart 600 showing a process of converting/transforming unstructured event logs into a uniform and simplified log format.

FIG. 7 is a component diagram 700 with flow-logging model for extracting and storing unstructured event logs in a uniform format.

FIG. 8A depicts a flow-logging model 800 used to capture and analyze events occurring during system operation of a software product 805.

FIG. 8B is a block diagram showing core and supplemental attributes of a log in accordance with one embodiment.

FIG. 9 depicts the component diagram 900 for enhancing a discovered process based on the theory of desirability.

FIG. 10 depicts a flowchart 1000 illustrating a method for software-product enhancement in accordance with one embodiment.

### DETAILED DESCRIPTION

A software product is a developed, packaged piece of software designed to perform specific tasks or provide functionalities, distributed for sale or free use. It can be cloud-based (accessed online) and includes end-user applications (e.g., word processors, games), system software (e.g., operating systems, drivers), middleware (e.g., connecting applications, databases), or development tools (e.g., integrated development environments, compilers). A software ecosystem is an interconnected network encompassing software products, developers, users, platforms, and services that collaborate to create, distribute, and enhance digital solutions. Managing and optimizing user experience across software products—used individually or collaboratively within and between vendors—is complex, as products and ecosystems must seamlessly interact to meet diverse user needs and drive innovation.

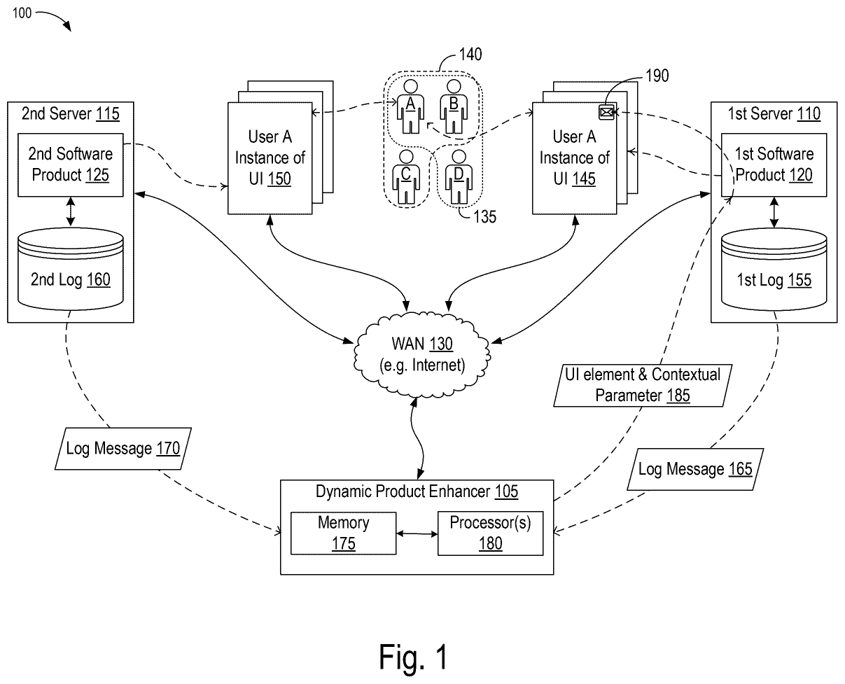

FIG. 1 depicts a software ecosystem 100 that dynamically improves the performance and interoperability of software products controlled and operated by product managers within the same or different businesses. Ecosystem 100 includes a dynamic product enhancer 105, a computer or process running on a computer communicatively coupled to first and second servers 110 and 115 that serve respective first and second software products 120 and 125 via a wide-area network (WAN) 130, such as the Internet. Servers 110 and 115 communicate with respective user groups 135 and 140 via instances of user interfaces (UIs) 145 and 150 on e.g. browsers supported on client computers (not shown).

Servers 110 and 115 also maintain respective event logs 155 and 160 that record users, user actions, and timestamps relating to the activities of the software products. Servers 110 and 115 periodically communicate their event logs as log messages 165 and 170 to product enhancer 105, which analyzes both event logs using internal or external memory 175 and processor(s) 180 to identify contextual parameter(s) that may impact the separate or collective performance of software products 120 and 125. Having identified an impactful contextual parameter, product enhancer 105 passes a message or command 185 to first server 110 to modify the first software product 120 for improved performance. In this example, command 185 passes an instruction to add a UI element 190 that when selected by a user (e.g. by a mouse click or touch) triggers a process that generates an email from User A to an employee that product enhancer 105 has found to be adept at resolving a particular customer-support issue or dealing with User A. The employee's email address is an example of a contextual parameter derived from either or both log messages 165 and 170, either directly as message content or looked up from a directory responsive to the employee identified in a log message.

Product enhancer 105 processes log messages 165 and 170 to discover product modifications that can improve the performance of the overall software ecosystem 100. The processing includes e.g. analyzing, merging, and correlating log entries with or without other information available to product enhancer 105. Based on that processing, intelligent actions are generated to improve the operation of the products. Product enhancer 105 can control a software product via (1) control of configuration options or product operational modes provided by each of the products (e.g. User Interface (UI) configuration options, data workflow options) or (2) helpful messages to users, support staff, or administrators of the software products (e.g. recommending improvements or updates to workflow of the product). In a dynamic example, an output coupling of product enhancer 105 pushes improvements to a software product's “configuration” or “instance” (e.g. UI or workflow).

The configuration options or product operational modes are supported by the product ahead of time and can be activated/deactivated or turned on/off as needed. They can be customized with specific contextual parameters as well. Product enhancer 105 has the ability to activate/deactivate or turn on/off these configuration options or product operational modes via its output coupling to the software product(s). The product enhancer 105, when activating or turning on a configuration option or product operational mode can further customize it with the parameters based on the context of the improvement needed in the product. The parameters may be determined, for example by analyzing logs from products, by analyzing user behavior, etc. In one embodiment a UI can be updated to display attribute or information specific to a user (e.g. monthly user expenses). Communication between product enhancer 105 and the software products may be implemented using APIs or Remote Procedure Calls in various embodiments.

Product enhancer 105 can determine a suitable UI element to be activated to incorporate a contextual parameter (For example, a parameter such as a telephone number may be part of the contextual information and a UI telephone icon is to be selected, rather than an email icon, or even a UI dialog box.) A UI element can be added, modified, or rendered actionable. A UI action can be related to a contextual parameter/information outside of logs 155 and 160. For example, a UI dialog box may be activated incorporating/displaying “contextual information” based on log analysis e.g. Select Storage Upgrade as needed: 3 TB, 5 TB, 10 TB where a selection of the required Storage Upgrade on the UI dialog box is permitted based on account information outside of the log files but available to product enhancer 105. The product enhancer can activate a passive element or otherwise modify the functionality of the user interfaces of software products responsive to or as directed by a contextual parameter. In the example of FIG. 1, UI 145 is modified to include or activate element 190, which when activated triggers a process that utilizes the contextual parameter to start a correspondence.

In one specific implementation, when the second software product is communication software, a parameter such as a telephone number (of a person or group handling the issue to be resolved) may be part of the contextual information and a UI telephone icon is the UI element to be activated or introduced in the UI. In another specific implementation, when the second software product is mail communication software, a parameter such as a mailID (of a person or group handling the issue to be resolved) may be part of the contextual information and a UI mail icon is the UI element to be activated or introduced in the UI. In another specific implementation, the first software product is ticketing software, and the second software product is procurement software with a ticketing workflow. User 1 of the first product raises a ticket for a new gadget, and the ticket is assigned to User 2, also a user of the first product. User 2 can use the second product to raise a new procurement request, tagging the ticket request raised in the first product by User 1, in which case User 2 gets access to a list of parameters (e.g. names of vendors, gadget configuration, etc.). User 2 selects one or more of these parameters, causing a new UI element to be included in the UI of the first product, e.g. a link to “Customize your order now!!!”. User 1 can interact with the link to select desired parameters based on factors like speed of delivery, cost, gadget review rating, etc.

Product enhancer 105 can improve software products by modifying or suggesting modifications to the workflow of a software product based on Key Performance Indicators (KPIs). Product enhancer 105 can also offer product managers or owners of software products suggestions for improvements. These suggestions can come from analysis of log files that are inaccessible to those in control of a software product, and that would thus go unnoticed by a product manager or others involved with software ecosystem 100. In the example of FIG. 1, User A has an improved user experience with software product 120 because of his or her interaction with software product 125. Product enhancer 105 merges and analyzes logs 155 and 160 to identify such cross-product opportunities for improvement and provide solutions.

In some embodiments a software product can support configuration options for product enhancer 105 to select from. For example, software product 120 can allow message 185 to select alternative UI configurations to present email alternatives or different approaches to product improvement. Product enhancer 105 can also communicate helpful messages to users, support staff, or administrators for dealing with product shortcomings. Product enhancer 105 might alert the owner of one or both software products that a user has been failing in attempts at contact. Such messaging can be particularly useful when a user of multiple software products blames the wrong product for a failure. For example, a customer having difficulty communicating with a software product for managing ticketing flow (e.g. Zoho's Manage Engine Service Desk Plus, Zoho Desk, Zoho Books, Zoho Inventory, Zoho CRM) may wrongly attribute the difficulty to the ticketing software when the fault lies with communication software (e.g. Zoho Cliq, Zoho Mail, Zoho Voice, Zoho Meeting, Zoho Assist). Product enhancer 105 evaluates both the ticketing and communication logs to identify users engaged with both software products experiencing a problem or for whom performance can be improved and modifies or suggests modifications to one or both software products to improve the users' experiences. Product enhancer 105 can likewise analyze cross-product event logs to improve key performance indicators (KPIs) of the overall software ecosystem, such as speed performance, memory usage, and power consumption.

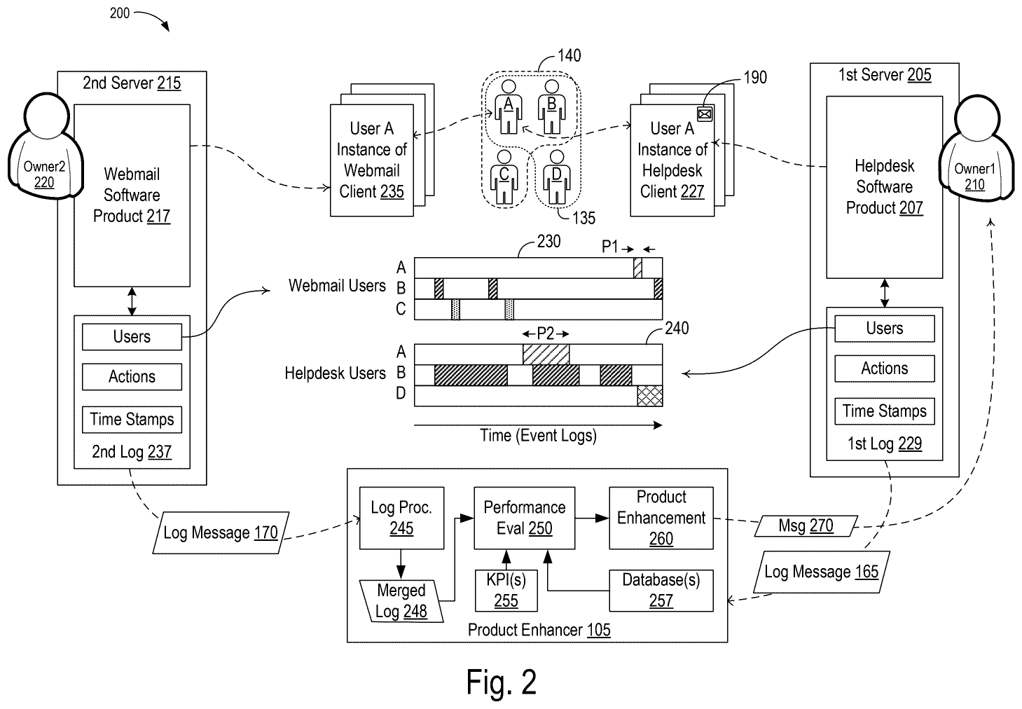

FIG. 2 depicts a software ecosystem 200 in accordance with another embodiment with like-identified elements being the same or similar to those of FIG. 1. Ecosystem 200 includes computer systems under control of different vendors represented by a first server 205 with a helpdesk software product 207 (ticketing-flow software) and owner 210 and a second server 215 with a webmail software product 217 (communication software) and owner 220. In another specific implementation, the products can have same owner. Product enhancer 105 automatically improves helpdesk software product 207 and messages owner 210 regarding suggestions and improvements responsive to user interactions with webmail software product 217. Product enhancer 225 thus improves overall user experience across separately controlled software products.

Server 205 serves user group 135 with helpdesk clients 227 and maintains an event log 229 that records users, user actions, and timestamps. Server 215 serves user group 140 with webmail clients 235 and maintains an event log 237.

An event can be any operation, state change, error, or user interaction that happens within the software, actions like: logins, logouts, button clicks, form submissions, state changes, or data transfers. An event log is a time-stamped record where each entry represents an event. Event logs can be stored in various formats, from simple text files to structured databases or specialized log management systems.

A graphical representation 230 of second log 237 includes timelines of events for each of users A, B, and C, events like drafting, sending, and reviewing email messages. A graphical representation 240 of first log 229 includes timelines of events for each of users A, B, and D, events like engaging in ticket creation, ticket submission, and issue handling with computer support professionals. One event for user A in log 229 and depicted in representation 230 takes place over a time period P1. Another event for user A in log 237 and depicted in representation 240 takes place over a time period P2 that occurs before period P1, showing that user A interacted with both webmail software product 217 and helpdesk software product 207. The interaction of user A with helpdesk software product 207 occurred ahead of the interaction of user A with webmail software product 217 but near enough in time to be related and assigned a common case ID.

Logs 229 and 237 are communicated to product enhancer 105 for consideration. Product enhancer 105 includes a log-processing module 245, a performance-evaluation module 250, a list of KPIs 255, a database 257, and a product-enhancement module 260. Log-processing module 245 normalizes and simplifies logs 229 and 237 to produce a merged log 248 for performance-evaluation module 250. Log-processing module 245 can also analyze or correlate the logs, and can identify users common to both groups and times during which common users are active across software products. This example includes two common users A and B, and module 250 further identifies user A's portions P1 and P2 of event logs 230 and 240 as indicating user A's concurrent use of helpdesk and webmail software products on servers 205 and 215.

KPIs 255 include indicators of user experience, such as time delays and user feedback, and performance parameters like power usage, revenue, and sales conversion rates. Database 257 represents local or remote proprietary or public information that may be relevant to the performance of all or a portion of software ecosystem 200. Performance-evaluation module 250 evaluates cross-platform user experience against KPIs 255 with or without information in database 257 to discover and implement product improvements to one or both of software products 207 and 217 responsive to user activity on either or both products. There can also be user experience metrics like duration to close the ticket, cost of closing the ticket, power consumed to close the ticket, etc.

Performance-evaluation module 250 notes from merged log 248 that some activity of user A improved upon a KPI after a timeframe encompassing periods P1 and P2. For example, the timeframe might encompass a mail interaction between User A and someone supporting helpdesk software product 208 that appears in the merged log. Responsive to the correlation between mail interaction and the KPI, or more likely a statistically significant number of such correlations, product-enhancement module 260 updates helpdesk software product 207 so that an instance or instances of helpdesk client 227 includes UI element 190 to facilitate email messages to the right person at the helpdesk. Product-enhancement module 260 may also send a message 270 suggesting or alerting owner 210 of the change to software product 207. Information outside of logs 229 and 237 can also be helpful. For example, performance evaluation module 250 may discover that a communication problem User A is having with helpdesk software 207 is due to insufficient cloud storage for User A's subscription to webmail software product 217. Product enhancer 105 can then rely on information from database 257 to suggest or implement a change in User A's webmail subscription, such as a temporary waiver of a storage limit to expedite resolution of a pending issue. User A's experience with one software product can thus inspire modifications to another software product even if the software products are under the control of different entities.

The modification to software product 207 to include or modify UI element 190 can be across clients 227 or unique to one or a subset of clients. For example, a parameter such as a telephone number may be part of the contextual parameter identified as helpful for a particular user interaction so a telephone UI element may be selected instead of or in addition to email UI element 190 for that user. Likewise, the aforementioned issue of User A's storage limitation is unique to User A, so a UI element unique to User A and the storage issue can be included in helpdesk client 227 for User A alone and removed when the issue is resolved. User A's experience with both software products is thus improved by the cross-product management of product enhancer 105. Both owners, or different project managers within the same business entity, likewise benefit.

A user pool is created with an initial log event, such as a ticket through helpdesk software product 207. The user pool includes a user and other human entities who are handling an issue associated with the ticket. The logs of one or more users in the user pool, created while they use a second software product, are processed to see if the log corresponds to the same case ID of an event log from the first software product. The user pool is augmented as more logs are processed or analyzed, which may involve more human entities as escalations may happen and cross-product issues require resolution. Log-processing module 245 can merge the logs, if the logs are created by the users in the user pool, and if the logs correspond to the same case ID. The time of creation of a first event log, such as the opening of a ticket, should be ahead of the time of creation of a second event log for the logs to be merged by log-processing module 245.

Owner 210 may control or grant control to product enhancer 105, in which case server 205 can modify helpdesk software product 207 dynamically responsive to message 270. Given appropriate credentials, product enhancer 105 can use tools like Remote Server Administration Tools (RSAT) for Windows, PowerShell Remoting, or SSH for Unix-based systems to manage and configure server 205, including UI-related components of software product 207. Product enhancer 105 could automatically modify registry settings (Windows) to tweak UI elements like taskbar behavior or window styles, edit configuration files (e.g., .bashrc or desktop environment settings on Linux) to change the UI, or deploy scripts or software to alter the UI programmatically.

Software product 215 was modified responsive to the activity of a single common user A in this example. Other embodiments require the number of user experiences to exceed a threshold before a change is made. Changes also need not be additive. Unused or ineffective features can be removed from one or both products 205 and 215 for improved KPIs.

Helpdesk software product 207 is in the customer-support genus. A user is added to event log 229 when the user opens a help ticket. The ticket can then be associated with a parameter of user experience to allow product enhancer 105 to evaluate and improve that parameter. The parameter can be a measure of performance for one or both software products with a goal of improving the overall user experience. In a cloud-computing environment, for example, modifying software product 207 responsive to all or a portion of event log 237 can improve the speed performance of the overall system, and thus the user experiences provided by instances 227 and 235, despite control being distributed between owners 210 and 220, or likewise between product managers in the same company.

Product enhancer 105 can improve the computational efficiency of remote servers by instructing them to dynamically scale their processor's clock frequency based on real-time workload demands. For example, product enhancer may note from log message 170 that User A is busy messaging a third party and is thus not engaged with helpdesk software product 207 despite there being an open ticket. Message 270 can instruct server 205 to momentarily slow or delay computations required for User A interactions to save power or can deprioritize User A in a helpdesk queue relative to Users actively engaged with the helpdesk. During high-demand tasks, with an actively engaged user, increasing processor frequency reduces delays and improves user experience (e.g., quicker response times in an app). Lowering processor frequency during idle or low-demand periods reduces energy usage.

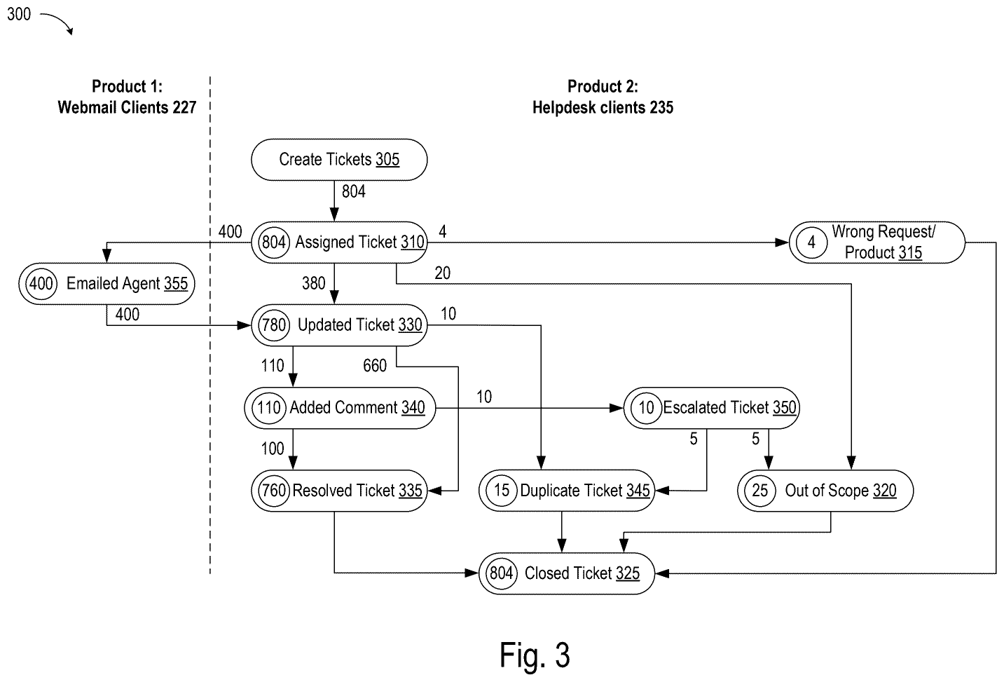

FIG. 3 shows a flowchart (300) that illustrates process discovery performed by an embodiment of product enhancer 105 from merged log 248 for first and second products 207 and 217 of FIG. 2. The process begins when users open help tickets (305). In this example, 804 help tickets are assigned (310). Out of these, four tickets are misdirected (315), and 20 are considered out of scope (320), so they are closed (325). In this example, 804 help tickets are assigned (210) to one or more users for the ticket to be resolved. Out of these, four tickets are misdirected (215), and 20 are considered out of scope (220) i.e. these 20 tickets are not the domain of user(s) to whom it is directed, which is described as “out of scope”.

Of the assigned tickets, 380 are updated (330). From these updated tickets: 660 are resolved (335) and then closed (325), one hundred ten have a comment added (340) before being resolved and closed, and ten are identified as duplicates (345) and closed. Additionally, ten of the tickets with comments are escalated in priority (350). Of these escalated tickets, five are found to be duplicates, and five are deemed out of scope. Four hundred of the assigned tickets produce email correspondence (355) with webmail clients 227. A customer might email an agent at the helpdesk, for example, with salient facts of the communication logged with an updated ticket (330).

Performance-evaluation module 250 tracks ticket processing to note patterns in the process flow. Emailed agents may correlate with the direct flow from updated tickets 330 to resolved tickets 335, reducing the time and effort involved with adding comments and escalating tickets. This noted benefit can inspire module 250 to suggest or implement a change to one or both clients 227 and 235 that facilitates earlier or easier communication by e.g. email, text, phone.

In today's digital workplace, each task/action/process associated with a product of a system leaves impressions and provides an indication of the used applications by the IT components. A task, action, or process refers to any incident that is recognized by the software systems. Incidents can originate either from the user or from the operating system, database, networks, servers, firewalls, hardware infrastructure, and others. Many important aspects can be inferred from the impressions and indicators of the components of the digital workplace. These aspects include traces and signals.

The trace refers to the flow or the path in between the starting and terminating points of an action/event/process, and the signals are called event logs. In other words, the trace specifies the catching and exact recording of the information associated with a program in execution or product in use. The event log is the file containing the list of all the events in chronological order. The event logs capture all the information about the hardware and software events and the changes made into the hardware or software. The terms “process logs” and “event logs” are used interchangeably. The event logs are commonly used in many IT systems, like customer relationship management systems (CRMs) and enterprise resource planning systems (ERPs). To illustrate further, an event log can be a structured file containing records and timings of all the events and activities within a computer database. Event logs are used to track changes to the database, such as changes to the data structure, data entry records, user logins, errors, warnings, and others.

Event logs can record something about the tasks, processes, and work executed in a team or business unit. The gathered event logs, or merged logs, are raw transaction data that is harmonized from different systems or products. The individual events associated with the products or systems that belong to an organization are listed in the event log along with some standardized properties appropriate for an organization.

The processes associated with a product or system of an organization are discovered, continuously monitored, and optimized by extracting certain information using the event logs. The data associated with the processes are recorded systematically in the existing organizational storage component that runs the business processes within an organization. Moreover, it is useful to relate, analyze, and transform the event logs into a more meaningful representation of a process. The process of inferring important decisions from the log files is beneficial, as it advocates the quantification of throughput and is helpful to reveal abnormal behavior, faults, and defects, like system errors, hardware issues, security breaches, and performance aspects associated with the system or the product. The information/decisions gathered from the log files can also be used to make data-driven decisions, solve business problems, and uncover hidden insights.

The collecting/sourcing of event logs constitutes the collection, gathering, and extraction of the event logs from several sources. The several sources can include the following.
A. Organization's Owned Products->both stand-alone (single systems, like: CRM) and bundled (multiple systems, like: CRM and messaging software).
B. Integrated Products->organization-owned products and the products belonging outside of the organization.
C. Outside Organization Products: event logs that were extracted completely from the outside organization products (these logs can be from single or multiple systems).

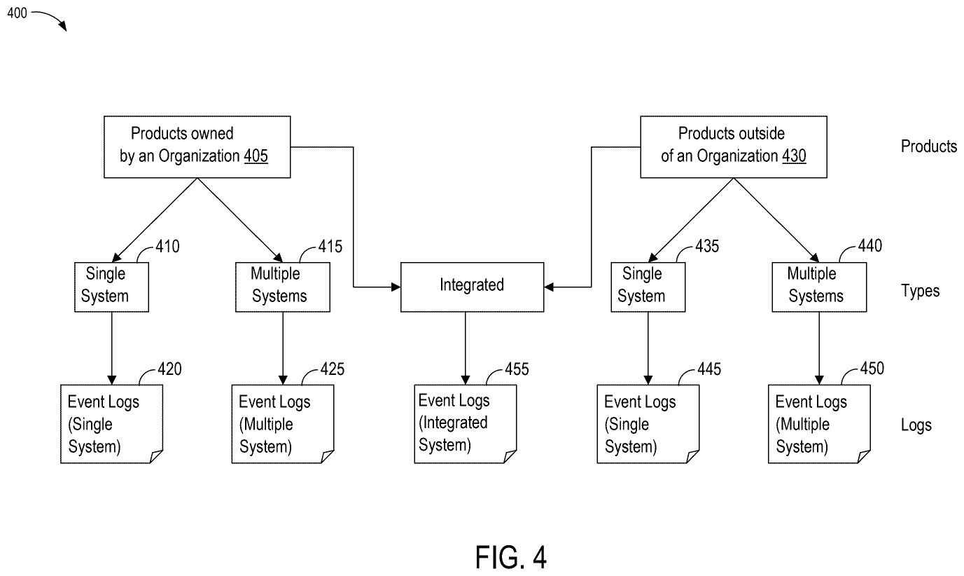

FIG. 4 shows a taxonomy diagram 400 of collecting different event logs and its corresponding sources. For example, the event logs (Integrated System) refer to a file containing the sequence of information based on a process/action that uses both the products (organization owned products and also the products outside of an organization). All these event logs are stored in a repository or storage component in raw format which can be processed further as per the requirements.

For measuring the key performance indicators (KPIs) of an organization owned product, there is a scope to analyze on the top of the extracted logs. This is because the organization's owned scope and standard methods of logging are available and applicable for its owned products. For hybrid products, the control of standard methods may not be available. Hybrid products combine one or more organization-owned products with a product or products outside of the organization. The KPIs are the parameters that are used to measure the performance of an organization over an interval based on a certain goal.

Diagram 400 shows products 405 owned by an organization organized into either a single system 410 or multiple systems 415 that produce respective event logs 420 and 425. Products 430 owned by an outside organization are likewise organized into either a single system 435 or multiple systems 440 that produce respective event logs 445 and 450. Logs from products 405 and 430 combined to produce merged logs 455.

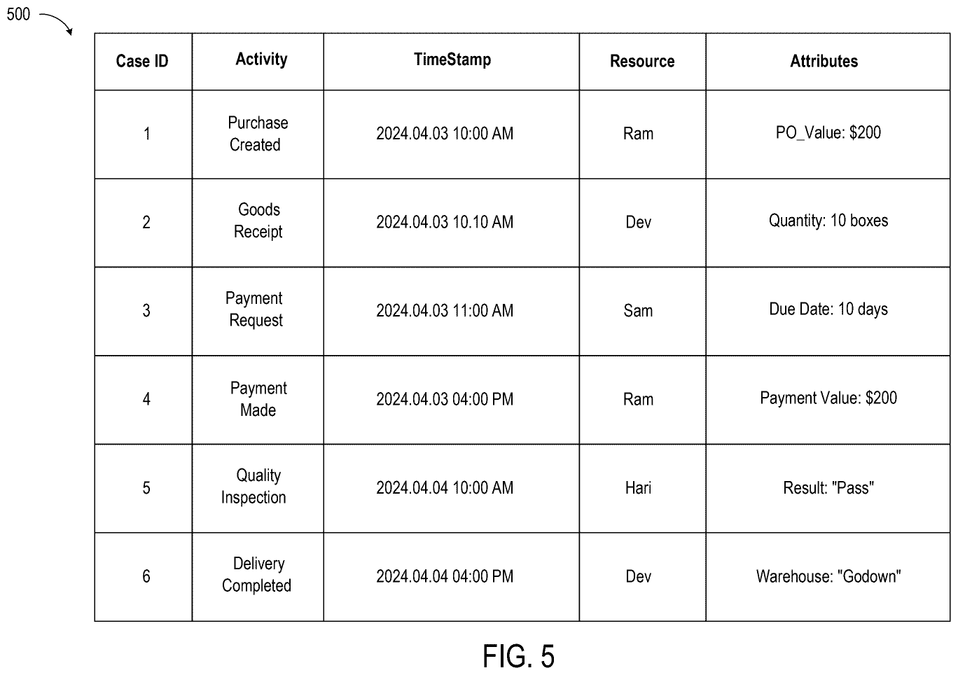

FIG. 5 depicts an example of an event log for a purchase process in table form. All individual events are listed in the event log along with the standard available properties.
A. CaseID: a CaseID is a unique identifier for any business object or transaction that is tracked in event logs.
B. Activity: is a task or action associated within a process, for example, approve, reject, or request.
C. Timestamps: a timestamp indicates when each of the activities took place. The timestamps have the time and the date.
D. Resource: the resource refers to the person responsible for initiating a process.
E. Attributes: there can be additional attributes stored in the event logs, like the process category or the product being processed, or information on which person or department made changes to the event.

Log entries are related to events. The example shown in FIG. 4 denotes the purchase process. Each process/event can have many attributes like: ‘CaseID’, ‘Time Stamp’, ‘Activity’, ‘Resource’, ‘Customers’, and others. Out of which, the first three are the primary attributes required for the discovery of the process, and together, they are known as the simplified logs.

Thus, simplified logs have ‘CaseID’, ‘Time Stamp’, and ‘Activity’. The simplified log is defined as a three-tuple structure having <CaseID, Time Stamp, Activity> which are comma separated. The log files provide information about important process events, such as changes in state, warnings, or errors, in a standard format. In order to maintain uniformity with respect to the used products, event logs of various formats (unstructured logs/traditional logs) are converted into a uniform and simplified log format.

Examples of traditional event log formats are: XES: (eXtensible Event Streams) and Object Centric Event Logs (OCEL), which includes the binary data format: XOC, JSON and XML.

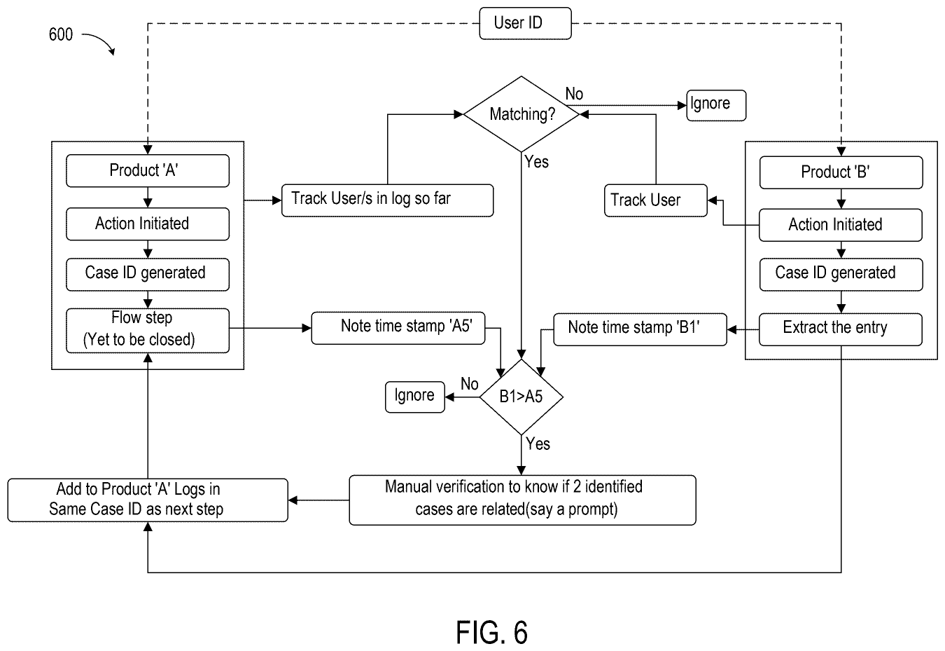

FIG. 6 is a flowchart 600 showing a process of converting/transforming unstructured event logs into a uniform and simplified log format. Event logs of software products are merged/combined based on the single user ID (UID) of a user and the timestamp to improve the business process or to infer important business-related information. The detailed steps of the transformation process are as follows.
A. Product A and Product B are two different products that are used by a user. The user is having permission to use both the products, where the identity of the user is identified with the help of a uniquely identified user ID (UID) field, which will be the same while the user is using the products.
B. When the user initiates an action in either of the products, a unique case ID (UCID) is generated by the logger unit for the user while using the products.
C. The flow of traces for an initiated process/task/action is recorded in the repository having all the parameters. The trace refers to the sequence of events in a chronological order for the initiated process.
D. Timestamp denotes the starting (entry) and closing (exit) points of the process/task/action, as noted by the system. It can be either the same or different for the two products.
E. Based on analyzing the noted timestamp, the system can decide whether to combine/add the event logs of both the products that are used by a single user.
F. The decision of verifying whether the two identified or extracted event logs are equal is based on manual user intervention. The example of manual intervention can be a prompt or dialog box, which needs a value from the user.

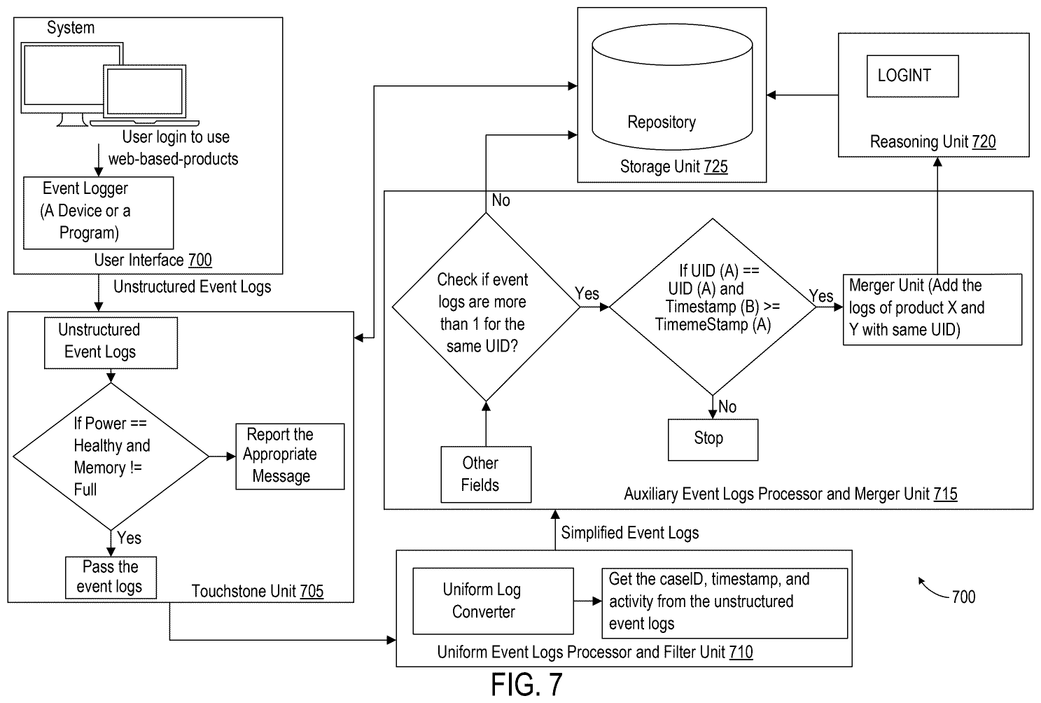

FIG. 7 is a component diagram 700 for extracting and storing unstructured event logs in a uniform format. The units are as follows.
A. User Interface Unit 702: The user is logged into the products and accesses the products for performing certain tasks. The tasks can be anything as per the user requirements. Example of task: placing a purchase order. The user can access either single or multiple products at a time. A product enhancer can define timeframes and user activity patterns that indicate or suggest a user is interacting with multiple software products at the same time, which is to say during a given period. In one embodiment, each log entry has the attributes user_id, timestamp, and product_id. The logs group events by user_id and are sorted based on event timestamps. The log processor looks for log entries with multiple product_ids under the same user_id within the same period. The event logger can be a device or program which is responsible for collecting event logs based on every activity performed by the user. The event logs captured by the event logger are in unstructured format. The event logger extracts the event logs in all possible formats as per the user activities to the products.
B. Touchstone Unit 705: The unstructured event logs are passed to the touch stone unit. The touchstone unit has access to the storage unit and does two main functionalities based on the event logger. If the event logger is a device, the touchstone unit checks for the power health, and if the event logger is a program, it checks for the memory. If the touchstone unit confirms the power of the device as healthy and the storage memory is not full, then it gets the unstructured event logs and passes them to the uniform event logs processor and filter unit. Otherwise, it reports/pop-up the appropriate message.
C. Uniform Event Logs Processor and Filter Unit 710: The uniform event logs processor and filter unit has a component called the uniform log converter. Its main function is to convert the unstructured event logs into simplified event logs. For this, it fetches the three attributes from the unstructured event logs. They are: <CaseID, Time Stamp, Activity>. It forwards the simplified event logs to the auxiliary event logs processor and merger unit.
D. Auxiliary Event Logs Processor and Merger Unit 715: The auxiliary event logs processor and merger unit is responsible for adding other key fields along with the simplified event logs. It prompts a pop-up to the user, and based on user choice or preference, it adds the same to the simplified event logs. Thus, a kind of flexibility is associated with the user. The user can add anything based on the desired requirements. This unit is also responsible for performing two checks before storing the event logs. The first check is associated user identity (UID). Here, the unit checks whether the same UID is associated with more than one event log. For the unsuccessful match, the unit confirms that there is only a single event log associated with the single UID, then it stores the same in the storage unit. Otherwise, for the successful match, it performs one more check. The user here is associated with two products, say (X and Y). The same can be validated by the unit, if the UID is common to both products event logs. For this case, if the timestamp of product X is greater than product Y, then the merger unit combines the logs of product X into product Y with the same UID. After merging the merger unit—a subcomponent of this unit stores the same in the storage unit. For the unsuccessful case, no merging happens and the merging process is stopped.
E. Reasoning Unit 720: This unit is responsible for tracking the sequence for the merged event logs. In other words, when the system is done with the transformation and merging of two unstructured event logs into a simplified format, it keeps the record of the sequence for the appropriate event logs. This is because using an individual/single product, multiple requests can be generated in several possible ways. An intelligent unit keeps track of the appropriate requests. This is done using the case ID for two different logs. The reasoning unit is having a component known as ‘LOG INT’, denoting the log intelligence sub-unit, which keeps track of the merged event logs using the case ID of the logs. It expands the merged event logs and stores the updated merged event logs with the corresponding case ID correctly. The input to the reasoning unit is the merged event logs, and the output of this unit are the updated merged event logs, which are stored in the repository.
F. Storage Unit 725: The storage unit has the repositories in the table format, which is responsible for storing the event logs in a uniform and simplified format. It also has access to the touchstone unit. The touchstone unit checks for power and memory usage as per the requirements.

After collecting the event logs from several sources, the goal is to transform all these event logs into some common or uniform format. The right-hand side of FIG. 7 shows the structure of the event log, what the event log should include, and the left-hand side specifies the entire process, like the traces and flow associated with the event log.

The first step of the flow logging model is to gather the key fields of the event log file. The key fields in this example are divided into core and supplementary groups, core fields being required for a specific implementation across software products, in this case case ID, activity, and time stamp. The supplemental fields are anything apart from the core fields and can be decided by the organization as per their requirements. Cost is an example of a supplemental field. Elements described herein as “core,” may be necessary for a particular software ecosystem but are not more broadly necessary for other embodiments.

Values that core and other key fields can have are shown in the left-hand side box just beside the key field. Together, key and values are known as the attributes component in the flow logging model. For each and every event associated with the product, the log file with necessary details is fetched and stored in a repository.

The flow denotes the traces or the paths based on an event. The traces can be viewed as a path/activities (in between) from the starting and the end point of an event. One event can have multiple paths from the starting point to the termination point. The logs can also be either added, deleted, or retained by the system as per the decision by the system.

A conformance check evaluates whether the process being followed aligns with the process that was planned. This check has two aspects.
A. Trust Factor: Trust values measure how reliable we assume each version of the process (the intended model or the observed data) to be. These values can depend on how the process representation was created—for example, whether it's based on solid evidence or educated guesses.
B. Through Artifacts: This check relies on analyzing specific clues (artifacts) from the process:
C. Behavioral Rules: The model sets rules, like the required order of activities. If the event log (a record of what actually happened) shows traces (sequences of events) that break these rules, there's a mismatch.
D. Token Replay: This method assumes every trace in the event log should match a valid sequence of steps in the process model. It simulates the process by “replaying” tokens through the model to see if the log fits.
E. Alignment: This involves lining up the events in a trace from the log with the tasks in a valid sequence from the model, checking how well they match.

Process discovery, process conformance, and process enhancements are important features of process mining. Process enhancements viewed or measured using the hypothesis of desirability are measured against KPI parameters (like: time, cost, resources and others). Current values of KPI parameters can be assumed to be undesirable and open for improvement. Product-enhancement modules and systems contemplate log data that contributes to the values of KPI parameters and adjust process parameters as needed to improve the desirability of KPI values.

Desirability factor understanding can be achieved with sentiment analysis (say, machine learning based) on particular parameters. The system decides on optimization aspects. Examples of undesirability are high expense and more lead time, whereas examples of a desirable state are low expense and high profit. There can be a primary parameter that contributes to a KPI, and there could be related parameters which aid the contribution. A product enhancer thus captures those parameters and the relevant action steps to focus and improve.

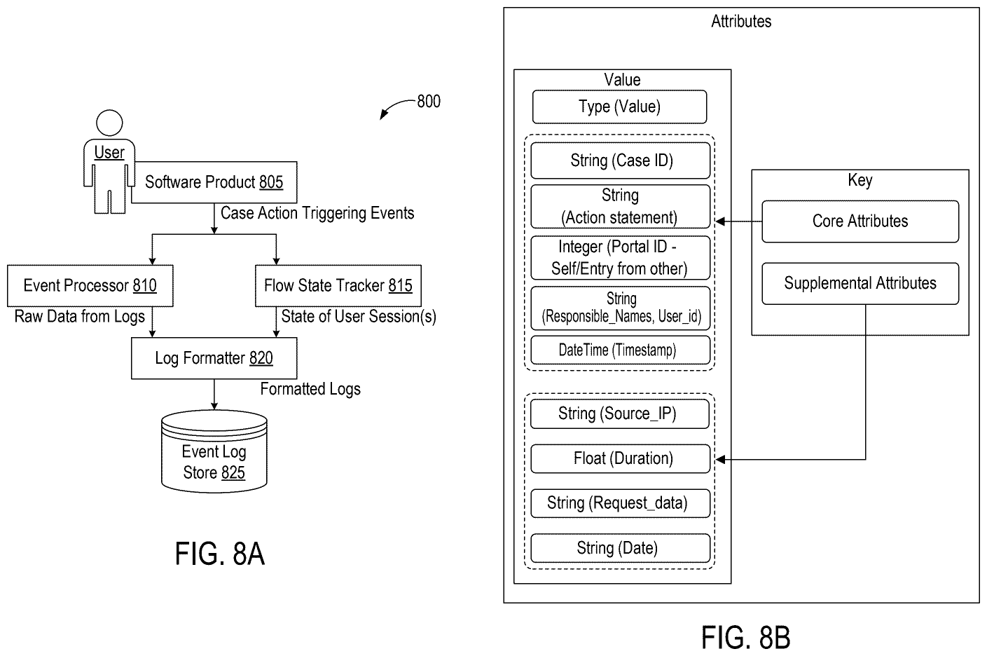

FIG. 8A depicts a flow-logging model 800 used to capture and analyze events occurring during system operation of a software product 805. System operation refers to the complete set of activities that can be either system-driven or user-initiated and that are executed by or within a software product, after a case initialization until an end state. These operations include user interactions like clicking, submitting data, navigating, assigning, commenting, attaching, etc.; and internal processes like data processing, API communication, error handling, etc. The events are captured and processed by an event processor 810.

A flow state tracker 815, also called a flow state tracer, supports the process of flow logging. Tracker 815 ensures that the system maintains context about where an event or process stands within a multi-step sequence, enabling tracing, intermediate step(s) from initiating a case to closing a case like passing, addition, subtraction step, etc.; recovery, behavior analysis, closing of a ticket, etc. Each event is recorded as a log entry, forming an action sequence—an ordered set of operations representing user activities or system behaviors. These logs help trace how data and actions flow through the system. A log formatter 820 formats the raw data based on the raw data from event processor 810 and its corresponding session information from flow state tracker 815. The formatted log is stored in an event log store 825. Each event log contains one or more core or supplemental attributes, each attribute a named datapoint in the log.

Each attribute includes a key and a value. The key is the attribute name (e.g., “event_type”). The value is the specific detail for that attribute (e.g., “user_login”). The example of core attributes, such as Timestamp, Case_ID (of type string), Action Statement (of type string), Portal_ID (of type integer), Responsible_name (of type string), user_id (of type string), etc, are critical for chronological tracking and contextual analysis. Additional supplemental attributes like source_ip (of type string), duration (of type float), request_data (of type string), etc. enrich the logs and provide deeper insights when needed. The formatted logs are simple in nature and ready to be discovered. The formatted logs are also critical for as-is process discovery mining. In another specific implementation, the system described in FIG. 8A handles flow logging of user actions across several products in the software ecosystem. Each product can have multiple users also.

FIG. 8B is a block diagram showing core and supplemental attributes of a log in accordance with one embodiment. Other embodiments can have different core and supplemental attributes.

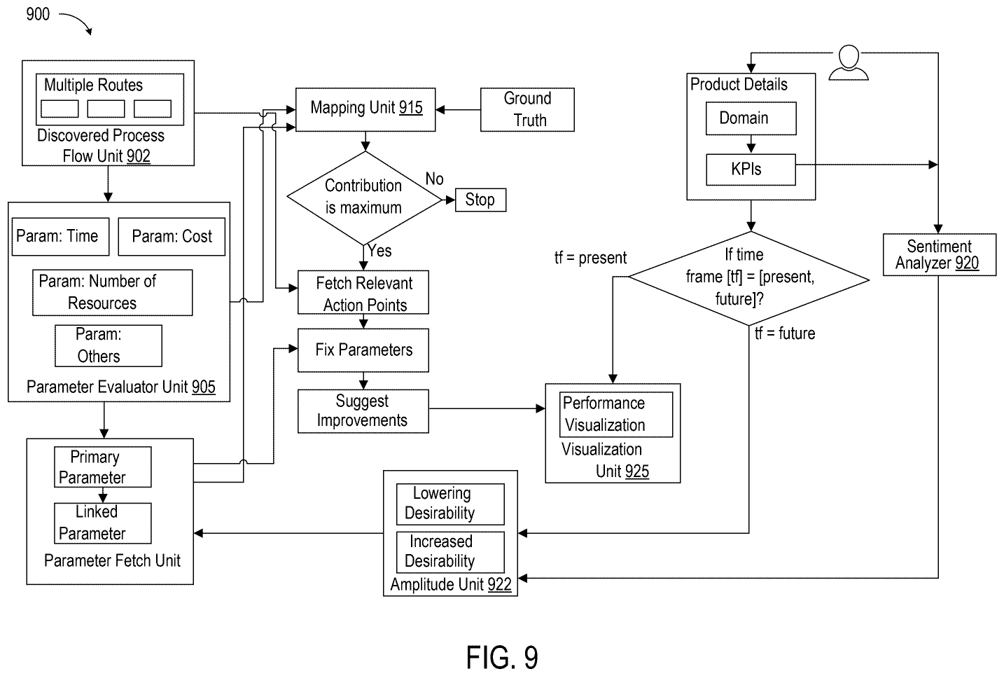

FIG. 9 depicts the component diagram 900 for enhancing a discovered process based on the theory of desirability. A discovered process flow unit 902 contains the multiple flows/paths or routes that are associated with a discovered process. A parameter evaluator unit 905 has all the parameters along with the necessary information. The parameters can be related to cost, time, or resources. The main objective of this unit is to evaluate and provide the primary and linked parameter associated with a discovered process to the parameter fetch unit.

The information from the parameter evaluator unit and the parameter fetch unit is mapped by a mapping unit 915 for a discovered process. The mapping unit has the ground truth for a process. The contribution is evaluated for a discovered process. If the contribution is maximum, then the other factors like action points and parameters are fetched accordingly and suggestions are provided. The action points are fetched from the discovered process flow unit, and the parameters are fetched from the parameter fetch unit. If the contribution is minimum, the process stops.

From a user, the domain and KPIs are collected by the system, the information related to KPIs serves as a precursor for the sentiment analyzer unit 920. The sentiment analyzer unit collects the facts or sentiments and forwards the same to an amplitude unit 922. Next, the time frame is fetched from the user, whether the user wants to analyze the process currently or the process has to be analyzed in the future. For the present case, the performance is visualized with the help of a visualization unit 925 and for the future case the information is passed to the amplitude unit. For the future case, the performance is visualized using the visualization unit. The visualization unit depicts the process using some graphical charts or plots.

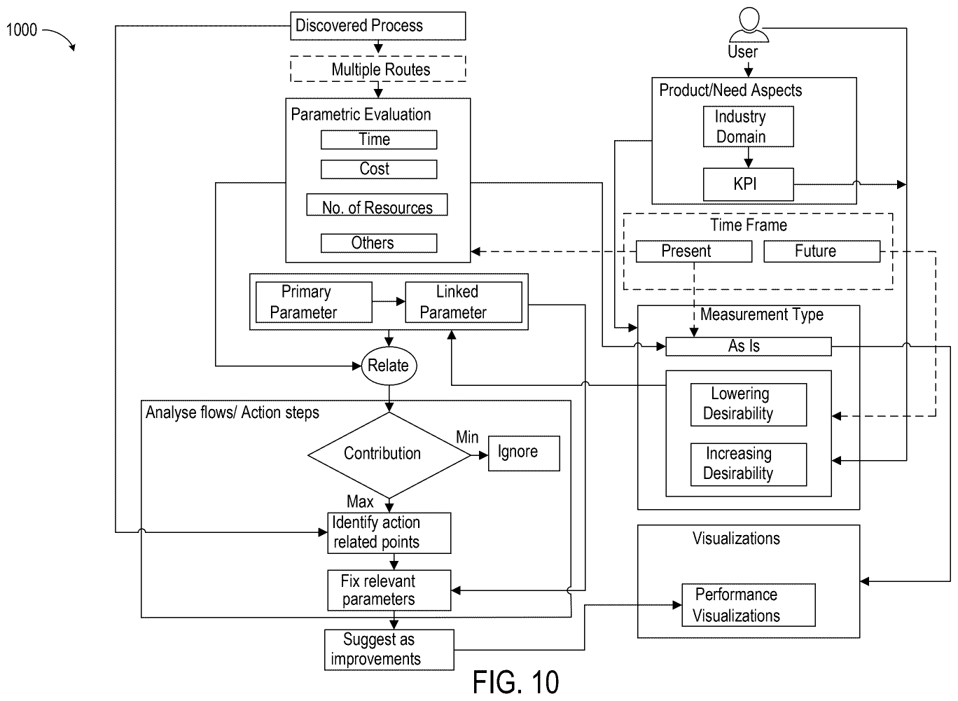

FIG. 10 is a flowchart 1000 depicting a method for software-product enhancement in accordance with one embodiment. The method converts event logs into simplified event logs using a user ID and a timestamp. The method supports modern business process notation models and types of data formats. The method also automatically captures and identifies desired factors for KPIs based on the hypothesis of desirability.

While the invention has been described with reference to specific embodiments thereof, it will be evident that various modifications and changes may be made thereto without departing from the broader spirit and scope of the invention. For example, features or aspects of any of the embodiments may be applied, at least where practicable, in combination with any other of the embodiments or in place of counterpart features or aspects thereof. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. A computer-implemented method to dynamically update a first software product, the method comprising:
serving the first software product in a software ecosystem to a first group of users, the first software product providing a first user interface and a first event log;
serving a second software product in the software ecosystem to a second group of users, the second software product providing a second user interface and a second event log;
analyzing the first event log and the second event log, using at least one processor, to identify a contextual parameter for at least one of the first software product and the second software product; and
modifying, with the at least one processor, the first software product in real-time and responsive to the analyzing to incorporate the contextual parameter into the first user interface.

2. The method of claim 1, the contextual parameter including at least one of a performance indicator, user-specific data, and environmental data.

3. The method of claim 1, further comprising modifying, with the at least one processor, the second software product responsive to the analyzing.

4. The method of claim 1, further comprising identifying a common user in both the first group of users and the second group of users, a first portion of the first event log associated with the common user, and a second portion of the second event log associated with the common user, wherein the modifying is responsive to at least one of the first portion and the second portion.

5. The method of claim 4, further comprising noting an experience of the common user recorded on at least one of the first portion and the second portion, wherein the modifying of the first software product is responsive to the noted experience.

6. The method of claim 4, wherein the first event log includes first time stamps and the second event log includes second time stamps, and wherein identifying the common user includes comparing the first time stamps to the second time stamps.

7. The method of claim 6, further comprising verifying whether one of the first time stamps marks a time before one of the second time stamps.

8. The method of claim 4, wherein the first software product comprises customer-support software, the method further comprising commencing the first portion responsive to the common user opening a ticket.

9. The method of claim 8, wherein the second software product comprises at least one of communication software and ticketing software.

10. The method of claim 8, further comprising associating the ticket with an experience metric, wherein modifying the first software product is responsive to the experience metric.

11. The method of claim 10, wherein the experience metric includes at least one of a duration to close the ticket, cost of closing the ticket, and power consumed to close the ticket.

12. The method of claim 1, wherein serving the first software product comprises creating an instance of the first software product for each user in the first group of users.

13. The method of claim 4, wherein the first software product and the second software product together exhibit a combined performance on a computer system and modifying the first software product responsive to the second portion of the second event log improves the combined performance.

14. The method of claim 13, wherein modifying the first software product responsive to the second portion of the second event log improves performance of the computer system in serving the first software product and the second software product over a time interval.

15. The method of claim 14, wherein serving the first software product and the second software product comprises creating instances of the first software product and the second software product for the common user, and wherein the improved performance comprises an increased execution speed of at least one of the instances.

16. The method of claim 14, wherein serving the first software product and the second software product comprises creating instances of the first software product and the second software product for the common user, and wherein the improved performance comprises an increased execution speed of the instances of the first software product and the second software product combined.

17. The method of claim 1, wherein modifying the first software product comprises customizing an element of the first user interface.

18. The method of claim 1, further comprising determining an element of the first user interface to be activated with the contextual parameter.

19. The method of claim 18, further comprising rendering the element of the user interface as an actionable element that, when activated, triggers a process that utilizes the contextual parameter.

20. The method of claim 1, wherein the first software product is under control of an owner, the method further comprising sending a message to alert the owner of the contextual parameter incorporated into the first user interface.

21. A system for dynamically updating a first software product, the system comprising:
a first server to serve a first software product to a first group of users, the first software product maintaining a first event log and providing each user in the first group of users with a first user interface;
a second server to serve a second software product to a second group of users, the second software product maintaining a second event log and providing each user in the second group of users with a second user interface; and
a computer, including at least one processor and having access to memory, communicatively coupled to the first server and the second server to receive the first event log and the second event log, the at least one processor configured to analyze the first event log and the second event log to identify a user common to the first software product and the second software product and a contextual parameter for the first software product, the computer to modify the first software product responsive to the analysis of the first event log and the second event log to incorporate the contextual parameter into the first user interface.
